(19) United States
(12) Patent Application Publication
(10) Pub. No.: US 2014/0184504 A1
(43) Pub. Date: Jul. 3, 2014

(54) ELECTRONIC DEVICE AND METHOD FOR CONTROLLING SCREEN ORIENTATION THEREOF

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); JIAN-HUNG HUNG, New Taipei (TW); XIN-SHU WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/093,497

(22) Filed: Dec. 1, 2013

(30) Foreign Application Priority Data
Dec. 28, 2012 (CN) 2012105846898

(51) Int. Cl. G06F 3/0346

(52) U.S. Cl. CPC G06F 3/0346
USPC 345/158

(57) ABSTRACT

A method for controlling a screen orientation for an electronic device is provided. The method comprises generating a sensing signal when an edge of the electronic device is held by a user, determining a screen display mode according to the sensed signal, determining a direction of a gravity vector from a center of gravity of the electronic device, determining a right-side-up display orientation according to the determined direction of the gravity vector, and displaying a screen in the right-side-up orientation under the determined screen display mode. An electronic device using the method for controlling the screen orientation is also provided.

### BACKGROUND

1. Technical Field

The present disclosure relates to electronic devices, and particularly to an electronic device and a method for controlling a screen orientation thereof.

2. Description of Related Art

Electronic devices such as tablet computers and mobile phones are equipped with gravity sensors. The electronic device determines whether to display a screen in a landscape orientation or a portrait orientation by detecting a direction of gravity. However, the screen of the electronic device is often not displayed in the desired orientation, especially when a user holds the electronic device while lying down.

Therefore, what is needed is an electronic device and a method for controlling a screen orientation thereof to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a schematic view of an embodiment of an electronic device.

FIG. 2 is a block diagram of an embodiment of function modules of the electronic device of FIG. 1.

FIGS. 3A and 3B are schematic views of an embodiment of the electronic device of FIG. 1 in use.

FIG. 4 is a flowchart of an embodiment of a method for controlling a screen orientation of the electronic devices of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

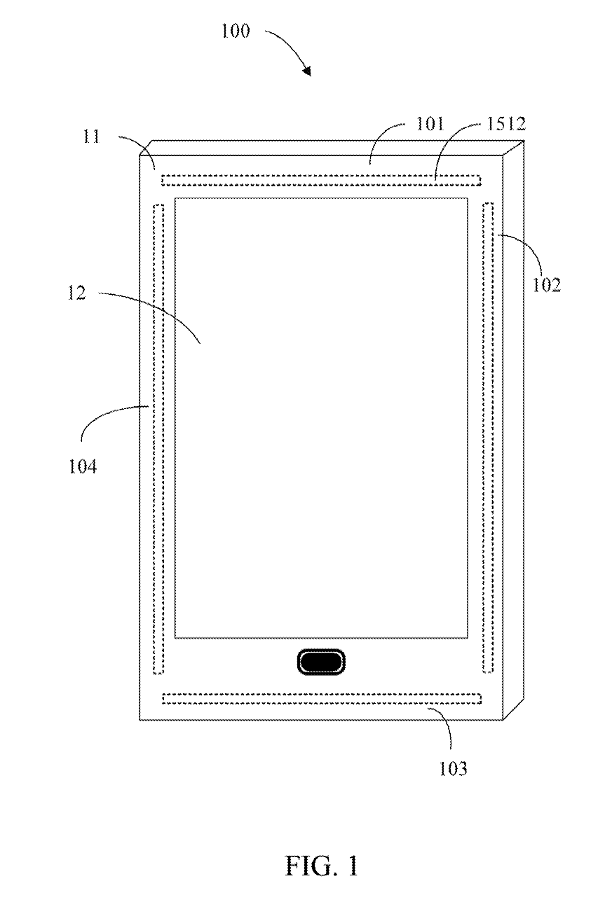

FIG. 1 is an exemplary embodiment of a disclosure of an electronic device 100. The electronic device 100 is a tablet computer. In alternative embodiments, the electronic device 100 can be other electronic devices, such as a mobile phone, an electronic reader, a digital phone frame, or the like.

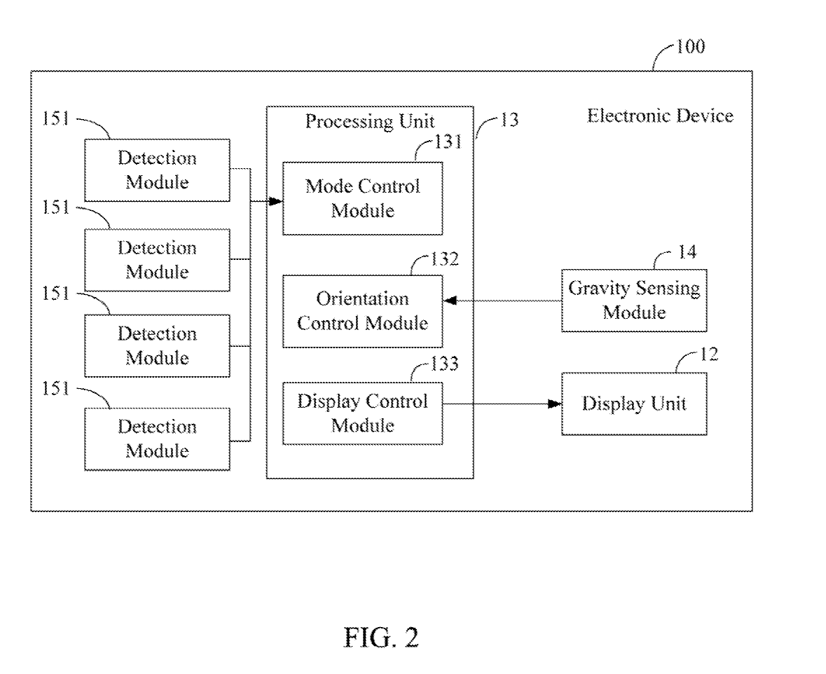

Referring to FIGS. 1 and 2, the electronic device 100 comprises a cover 11, a display unit 12, a processing unit 13, a gravity sensing module 14, and a number of detection modules 151. The gravity sensing module 14 comprises a gravity sensor for sensing a center of gravity of the electronic device 100 and a direction of a gravity vector from the center of gravity.

In the embodiment, the electronic device 100 comprises four detection modules 151. Each detection module 151 comprises an elongated pressure sensing bar 1512 and a signal generator (not shown). The detection modules 151 are arranged under the cover 11 and adjacent to a corresponding edge of the electronic device 100, and each detection module 151 extends along a direction of the corresponding edge of the electronic device 100. The electronic device comprises a first edge 101, a second edge 102, a third edge 103, and a fourth edge 104. The first and third edges 101, 103 are short edges substantially parallel to each other, and the second and fourth edges 102, 104 are long edges substantially parallel to each other. The four edges surround the display unit 12. The sensing bar 1512 is made of piezoelectric material and used for sensing a pressure applied on the corresponding edge of the cover 11. The sensing bar 1512 also transmits an electric signal to the signal generator to generate a sensing signal to the processing unit 13. The sensing signal comprises information of the sensing bar 1512.

In an alternative embodiment, the detection module 151 can comprise a light sensor instead of the pressure sensing bar 1512. The light sensor senses intensity of ambient light and transmits a corresponding electric signal to the signal generator. The signal generator of the detection module 151 generates a sensing signal if the intensity of the ambient light on the associated edge falls below a predetermined value.

The processing unit 13 comprises a mode control module 131, an orientation control module 132, and a display control module 133.

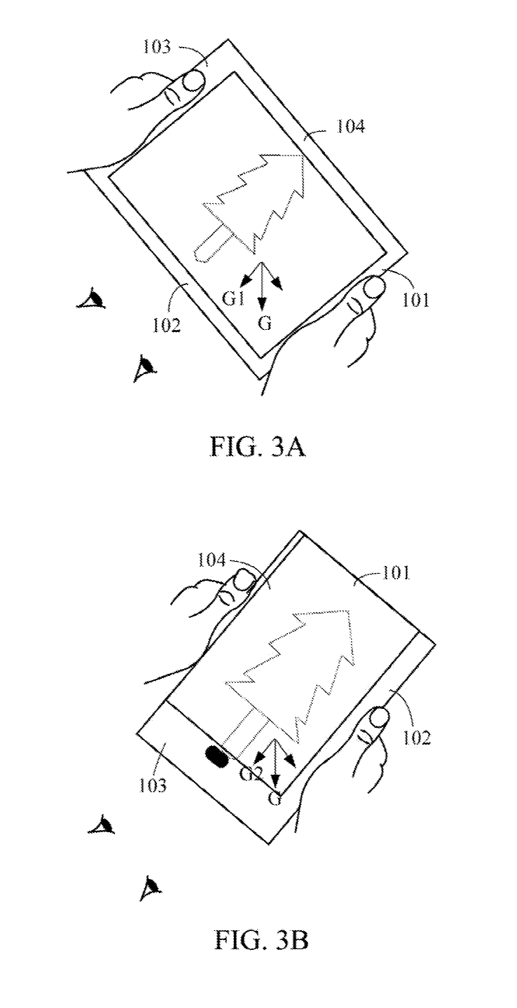

The mode control module 131 is configured for determining a screen display mode according to the sensing signals transmitted from the detection modules 151 during a predetermined time period. The predetermined time period is a relatively short time period, such as 1 second or 2 seconds. In the embodiment, the mode control module 131 determines the edge(s) held by a user according to which detection module(s) 151 transmit(s) the sensing signal(s) during the predetermined time period, and determines which screen display mode is required accordingly. For example, when the sensing signals are transmitted from the detection modules 151 associated with the first and third edges 101, 103, the mode control module 131 determines that a landscape mode is required for the electronic device 100 (see FIG. 3A). When the sensing signals are transmitted from the detection modules 151 associated with the second and fourth edges 102, 104, the mode control module 131 determines that a portrait mode is required for the electronic device 100 (see FIG. 3B).

The orientation control module 132 is configured for orienting the screen display in a right-side-up orientation according to the sensed direction of the gravity vector from the center of gravity of the electronic device 100 detected by the gravity sensing module 14. In the embodiment, the orientation control module 132 determines the direction of a gravity vector G1 relative to the screen display mode. For example, if the user is holding the first edge 101 and the second edge 103, after the mode control module 131 sets the screen display mode in the landscape mode, if the orientation control module 132 determines that the direction of the gravity vector G1 is towards the second edge 102 of the electronic device 100 (see FIG. 3A), the orientation control module 132 orients the screen display in the right-side-up orientation. If the user rotates the electronic device 100 180 degrees, the orientation control module 132 detects that the direction of the gravity vector is towards the fourth edge 104, and the orientation control module 132 rotates the screen display 180 degrees to orient the screen display in the right-side-up orientation. If the screen display mode is the portrait mode, the orientation control module 132 orients the screen display in the right-side-up orientation in a similar manner (see FIG. 3B) by determining a direction of a gravity vector G2.

The display control module 133 controls the display unit 12 to display the screen in the oriented screen display orientation under the determined screen display mode.

In an alternative embodiment, the electronic device 100 comprises two detection modules 151. The two detection modules 151 are arranged adjacent to adjacent edges, such as the first edge 101 and the second edge 102, respectively. The mode control module 131 determines the screen mode according to which detection module 15 transmits the sensing signal. For example, if the sensing signal is transmitted by the detection module 151 arranged at the short edge, the mode control module 131 determines that the landscape mode is required. If the sensing signal is transmitted by the detection module 151 arranged at the long edge, the mode control module 131 determines that the portrait mode is required. In another embodiment, the electronic device 100 comprises three detection modules 151 arranged at three edges, respectively.

When the user holds the electronic device 100, the edges of the electronic device 100 held by the user are determined by the detection module 151, and the direction of the gravity vector from the center of gravity is determined by the gravity sensing module 14. Thus, the electronic device 100 can accurately orient the screen display as desired by the user, even when the user is lying down.

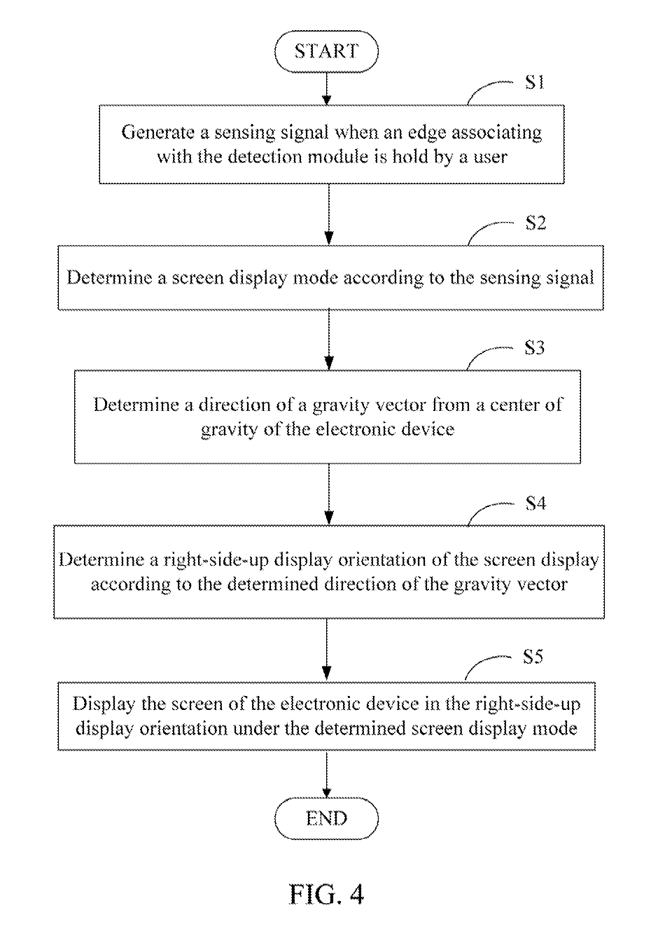

FIG. 4 shows a flowchart of a method for controlling a screen orientation of the electronic device 100 of FIG. 1. The method comprises the following steps.

In step S1, the detection module 151 generates a sensing signal when an edge associated with the detection module 151 is held by a user, and transmits the sensing signal to the processing unit 13. In the embodiment, the detection module 151 comprises a pressure sensor, and the detection module 151 generates a sensing signal in response to a pressure applied on the associated edge. In an alternative embodiment, the detection module 151 comprises a light sensor, and the detection module 151 generates a sensing signal when intensity of ambient light on the associated edge falls below a predetermined value.

In step S2, the mode control module 131 determines a screen display mode according to the sensing signal.

In step S3, the gravity sensing module 14 determines a direction of a gravity vector from a center of gravity of the electronic device 100.

In step S4, the orientation control module 132 determines a right-side-up display orientation of the screen display according to the determined direction of the gravity vector.

In step S5, the display control module 133 controls the display unit 12 to display the screen of the electronic device 100 in the right-side-up display orientation under the determined screen display mode.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic comprising:
a cover comprising four edges, two of which are short edges parallel to each other and the other two of which are long edges parallel to each other;
a display unit;
a plurality of detection modules, each of which associates with and is arranged under an edge of the cover, and is configured for generating a sensing signal when the associated edge is held by a user;
a gravity sensing module, configured for determining a direction of a gravity vector from the center of gravity of the electronic device;
a processing unit, comprising:
a mode control module, configured for determining a screen display mode according to the sensing signals;
an orientation control module, configured for orienting the screen display in a right-side-up orientation according to the sensed direction of the gravity vector from the center of gravity of the electronic device; and
a display control module, configured for controlling the display unit to display the screen in the oriented screen display orientation under the determined screen display mode.

2. The electronic device as described in claim 1, wherein the quantity of the plurality of detection modules is four, and each of the detection modules is adjacent to a corresponding edge of the electronic device, and extends along a direction of the corresponding edge of the electronic device.

3. The electronic device as described in claim 1, wherein the screen display mode comprises a landscape mode and a portrait mode.

4. The electronic device as described in claim 1, wherein each of the plurality of detection module comprises a pressure sensor, and the plurality of detection modules generate sensing signals in response to pressures applied on the associated edges.

5. The electronic device as described in claim 1, wherein each of the plurality of detection module comprises a light sensor, and the plurality of detection modules generate sensing signals when an intensity of the ambient light on the associated edges falls below a predetermined value.

6. A method for controlling a screen orientation for an electronic device, the method comprising:
generating a sensing signal when an edge of the electronic device is held by a user;
determining a screen display mode according to the sensing signal;
determining a direction of a gravity vector from the center of gravity of the electronic device;
orienting the screen display in a right-side-up orientation according to the sensed direction of the gravity vector from the center of gravity of the electronic device; and
displaying a screen of the electronic device in the oriented screen display orientation under the determined screen display mode.

7. The method as described in claim 6, further comprising sensing a pressure applied on the associated edge to determine if the edge of the electronic device is being held by a user.

8. The method as described in claim 6, further comprising determining whether the intensity of the ambient light on the associated edge falls below a predetermined value to determine if the edge of the electronic device is being held by a user.
